(19) United States
(12) Patent Application Publication
(10) Pub. No.: US 2012/0016941 A1
(43) Pub. Date: Jan. 19, 2012

(54) METHOD, SYSTEM AND APPARATUS FOR CONTROLLING A DISPLAY

(75) Inventors: Katerina Doudkine, Haverhill, MA (US); John Bennett Parrett, Amherst, MA (US)

(73) Assignee: RESEARCH IN MOTION LIMITED, Waterloo (CA)

(21) Appl. No.: 12/837,975

(22) Filed: Jul. 16, 2010

(51) Int. Cl. G06F 15/16

(52) U.S. Cl. 709/206

(57) ABSTRACT

According to embodiments described in the specification, a method, system and apparatus for controlling a display are provided. The method comprises maintaining, in a memory of the portable electronic device, one or more related messages; maintaining, in the memory, at least one of a plurality of labels in association with at least one of the related messages; determining, for each of the plurality of labels, a state based on the number of related messages with which the respective label is associated; controlling the display to generate a representation of the state for each of the labels; receiving an indication of a potential change in at least one of the label states; and, responsive to receiving the indication, updating the determined label states and controlling the display to generate an updated representation.

### FIELD

The specification relates generally to mobile electronic devices, and specifically to a method, system and apparatus for controlling the display of a mobile electronic device.

### BACKGROUND

While the capabilities of mobile electronic devices such as cellular telephones and smart telephones continue to increase in terms of computational power, storage space and the like, the usage of such devices is also becoming more widespread. With such widespread use comes demand for ever greater functionality. This demand can outpace the improving technical attributes of such devices. As a result, there remains a need for frugal use of mobile electronic devices' resources.

### BRIEF DESCRIPTIONS OF THE DRAWINGS

Embodiments are described with reference to the following figures, in which:

FIG. 1 depicts a communications system, according to a non-limiting embodiment;

FIG. 2 depicts a message store maintained by the mobile electronic device of FIG. 1, according to a non-limiting embodiment;

FIG. 3 depicts a representation generated by a display of the mobile electronic device of FIG. 1, according to a non-limiting embodiment;

FIG. 4 depicts a method for controlling a display, according to a non-limiting embodiment;

FIG. 5 depicts a method for performing block 410 of the method of FIG. 4, according to a non-limiting embodiment;

FIG. 6 depicts another representation generated by the display of the mobile electronic device of FIG. 1, according to a non-limiting embodiment;

FIG. 7 depicts a modified message store maintained by the mobile electronic device of FIG. 1, according to a non-limiting embodiment; and

FIG. 8 depicts a further representation generated by the display of the mobile electronic device of FIG. 1, according to a non-limiting embodiment.

### DETAILED DESCRIPTION OF THE EMBODIMENTS

According to an aspect of the specification, a method of controlling a display of a mobile electronic device is provided. The method comprises maintaining, in a memory of the portable electronic device, one or more related messages; maintaining, in the memory, at least one of a plurality of labels in association with at least one of the related messages; determining, for each of the plurality of labels, a state based on the number of related messages with which the respective label is associated; controlling the display to generate a representation of the state for each of the labels; receiving an indication of a potential change in at least one of the label states; and, responsive to receiving the indication, updating the determined label states and controlling the display to generate an updated representation.

According to another aspect of the specification, a mobile electronic device is provided. The mobile electronic device comprises a display; a memory for maintaining one or more related messages and at least one of a plurality of labels in association with at least one of the related messages; and, a processor, the processor configured to determine, for each of the plurality of labels, a state based on the number of related messages with which the respective label is associated; the processor further configured to control the display to generate a representation of the state for each of the labels; the processor further configured to receive an indication of a potential change in at least one of the label states, to update the determined label states and to control the display to generate an updated representation.

According to a further aspect of the specification, a computer readable storage medium is provided for storing computer readable instructions for execution by a processor. The computer readable instructions implement a method comprising maintaining, in a memory of the portable electronic device, one or more related messages; maintaining, in the memory, at least one of a plurality of labels in association with at least one of the related messages; determining, for each of the plurality of labels, a state based on the number of related messages with which the respective label is associated; controlling the display to generate a representation of the state for each of the labels; receiving an indication of a potential change in at least one of the label states; and, responsive to receiving the indication, updating the determined label states and controlling the display to generate an updated representation.

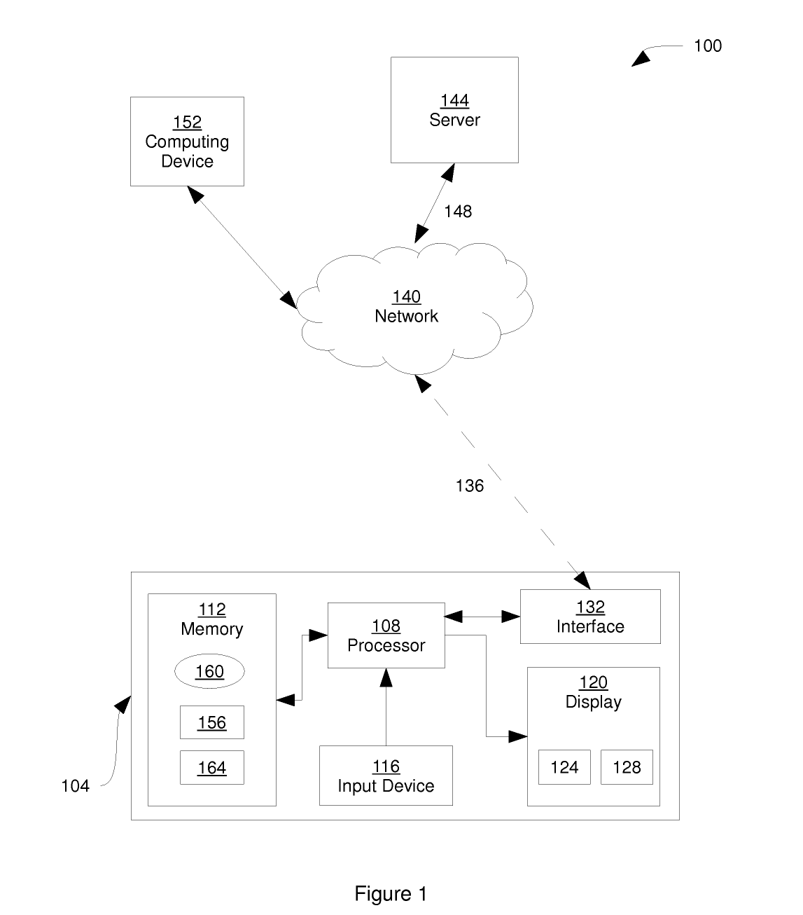

FIG. 1 depicts a communications system 100. System 100 includes a mobile electronic device 104, which in the present embodiment is based on the computing environment and functionality of a hand-held wireless communication device. It will be understood, however, that mobile electronic device 104 is not limited to a hand-held wireless communication device. Other mobile electronic devices are also contemplated, such as cellular telephones, smart telephones, Personal Digital Assistants (“PDAs”), media or MP3 players, laptop computers and the like. Mobile electronic device 104 includes a processor 108 interconnected with a computer readable storage (i.e. non-transitory) medium such as memory 112. Memory 112 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. Mobile electronic device 104 also includes one or more input devices 116 interconnected with processor 108. Input device 116 is generally configured to receive input and provide input data to processor 108. Input device 116 can include any suitable combination of keypads, microphones, touch screens and the like. It will be understood that in embodiments where input device 116 includes a touch screen, the touch screen can be integrated with display 120.

Mobile electronic device 104 further includes one or more output devices, such as a display 120. It will be appreciated that other output devices are also contemplated, such as a speaker (not shown), a light-emitting indicator such as a Light Emitting Diode (LED) (not shown) and the like. Display 120 includes display circuitry 124 controllable by processor 108 for generating representations 128 of data and/or applications maintained in memory 112. It will now be apparent that display 120 can include a flat panel display (e.g. Liquid Crystal Display (LCD), plasma, and the like), a Cathode Ray Tube (CRT), and the like. Circuitry 124 can thus include any suitable combination of display buffers, transistors, electron beam controllers, LCD cells, plasma cells, phosphors, and the like. It will also now be apparent that a touch screen input device can be integrated with display 120.

Mobile electronic device 104 also includes a communications interface 132 interconnected with processor 108. Communications interface 132 allows mobile electronic device 104 to communicate with other computing devices via a link 136 and a network 140. Network 140 can include any suitable combination of wired and/or wireless networks, including but not limited to a Wide Area Network (“WAN”) such as the Internet, a Local Area Network (“LAN”), cell phone networks, WiFi networks, WiMax networks and the like. Link 136 is compatible with network 140. In particular, link 136 can be a wireless link based on Global System for Mobile communications (“GSM”), General Packet Radio Service (“GPRS”), Enhanced Data rates for GSM Evolution (“EDGE”), and the third-generation mobile communication system (3G), Institute of Electrical and Electronic Engineers (“IEEE”) 802.11 (WiFi) or other wireless protocols. It will be understood that link 136 can also include any base stations and backhaul links necessary to connect mobile electronic device 104 to network 140. It will be understood that communications interface 132 can therefore be selected for compatibility with link 136 as well as with network 140.

The various components of mobile electronic device 104 are interconnected, for example via a communication bus (not shown). Mobile electronic device 104 can be powered by a battery (not shown), though it will be understood that mobile electronic device 104 can also be supplied with electricity by a wired connection to a wall outlet or other power source, for example when docked.

System 100 also includes a server 144, which can be based on any known server environment. As such, server 144 includes one or more processors, volatile (e.g. Random Access Memory (“RAM”)) and/or non-volatile (e.g. read only memory (“ROM”), Electrically Erasable Programmable Read Only Memory (“EEPROM”), flash memory, magnetic computer storage device, or optical disc) memories and one or more communications interfaces for interconnecting with network 140 via a link 148. Link 148 can be, for example, a wired link. Server 144 can be managed by way of input and output devices (not shown) such as a keyboard and a display. Such input and output devices can be co-located with server 144 or can be located at a terminal (not shown) remote from server 144 and connected to server 144 via network 140.

In general, mobile electronic device 104 can receive communications from other computing devices such as computing device 152. Although e-mail messages will be discussed herein for illustrative purposes, it will be now be apparent that such communications can also include Short Message Service (SMS), or text, messages, Multimedia Message Service (MMS) messages and the like. Computing device 152 can be a personal computer, another mobile electronic device or any other computing device suitable for transmitting messages. E-mail messages can be received from computing device 152, via network 140, at a communications interface of server 144. Server 144 can be a mail server hosting an e-mail account associated with mobile electronic device 104. In some embodiments, server 144 can “push,” or automatically forward, such communications to mobile electronic device 104. In other embodiments, server 144 can forward communications to mobile electronic device 104 in response to “pull” requests from mobile electronic device 104. In any event, the e-mail messages are received at communications interface 132 of mobile electronic device 104.

Following their arrival (whether from server 144 or from any other computing device) at mobile electronic device 104, e-mail messages can be maintained in memory 112. E-mail messages can be maintained, for example, in a message store 156 within memory 112.

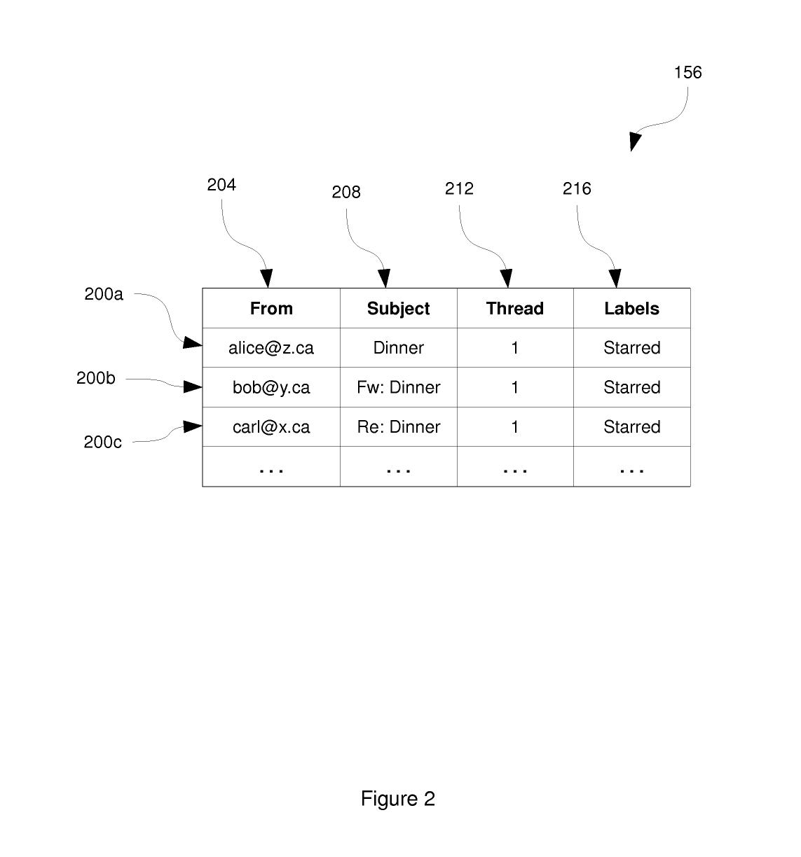

Referring now to FIG. 2, an exemplary message store 156 is depicted. It will be understood that while message store 156 is depicted in a tabular format, any suitable format can be used. Message store 156 can contain a plurality of e-mail messages, each defined by a record in message store 156. Exemplary e-mail message records 200a, 200b, 200c and so on (collectively referred to as e-mail messages 200, and generically as an e-mail message 200) are shown in FIG. 2. Each e-mail message 200 in message store 156 can include a “From” field 204, a “Subject” field 208, a “Thread” field 212 and a “Labels” field 216. It will now be apparent that other fields, such as a field containing the message body, a field containing the time of receipt, and the like, can also be included, though they are not shown in FIG. 2.

Some or all of the e-mail messages in message store 156 can be related to each other. Related e-mail messages are part of the same “thread” or “conversation”. Whether a given message is related to another can be determined in a variety of ways. For example, e-mail messages having the same, or substantially the same, subject lines can be considered related. For example, e-mail messages 200a, 200b and 200c in FIG. 2 can be considered related, as they each include substantially the same subject line (i.e. “Dinner”), discounting leading tags such as “Fw:” and “Re:”. Relatedness can be indicated explicitly within message store 156 in thread field 212, though it will be understood that this is not a necessity. When thread field 212 is employed to indicate relatedness, a common indicator can be stored in thread field 212 for each one of a plurality of related messages. Referring again to FIG. 2, thread field 212 contains the indicator “1” for each of e-mail messages 200a, 200b and 200c, thus indicating that all three messages are related. An additional set of related messages (not shown) could, for example, include a different indicator to indicate that they are related to each other but not to the messages of thread “1”.

Message store 156 can also include one or more labels maintained in association with some or all of e-mail messages 200. A label can be stored in association with an e-mail message in order to categorize the message, or to draw attention to the message. Referring again to FIG. 2, label field 216 of message store 156 contains a “Star” label in association with each of e-mail messages 200. It will now be apparent that a wide variety of labels can be stored in association with an e-mail message 200. Examples of labels include labels indicating the subject matter (i.e. keyword labels) of the e-mail message, labels indicating a folder in which the e-mail message is stored within message store 156 (e.g. Inbox, Sent Mail, Junk, Deleted and the like), and labels indicating the status of the e-mail message (e.g. Important, To Do and the like). Further labels will occur to those skilled in the art.

Returning to FIG. 1, mobile electronic device 104 can also maintain one or more messaging applications, such as a messaging application 160, in memory 112. Messaging application 160 comprises computer readable instructions for execution by processor 108. Processor 108 can be configured, by execution of messaging application 160, to control display circuitry 124 of display 120 to generate representations 128 of data contained in message store 156.

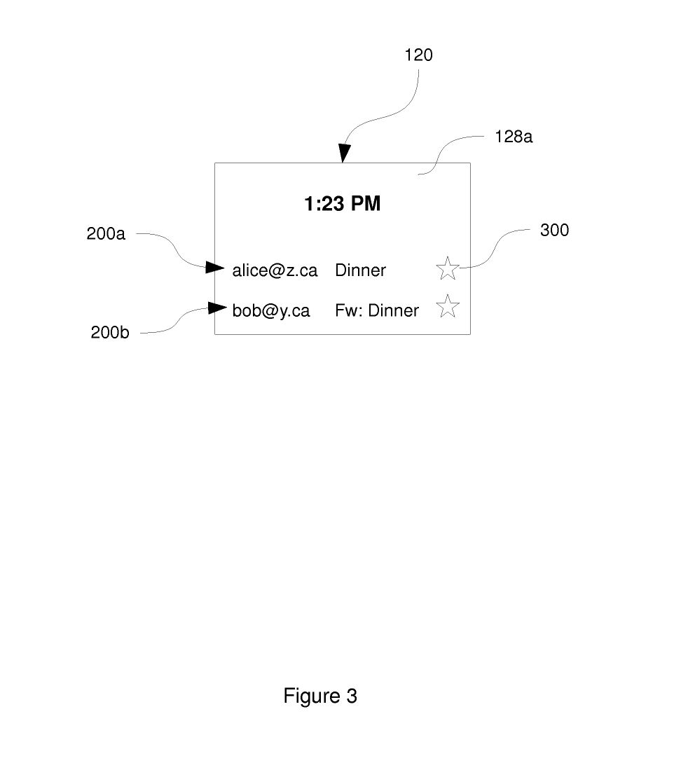

Turning now to FIG. 3, display 120 is depicted with an exemplary representation 128a of messaging application 160. Included in representation 128a are representations of the “From”, “Subject” and “Labels” fields of e-mail messages 200a and 200b. Data contained within labels field 216 is represented by a star icon 300 for the label “Star” as seen in FIG. 2. It will be apparent that other representations of labels are also contemplated. For example, a different icon can be used for the “Star” or any other label. In some embodiments, textual representations can be used instead of, or in addition to, graphical representations like icon 300. In further embodiments, labels can be represented by colour-coding at least a portion of the representation of an e-mail message. For example, the background of the subject line can be rendered in a certain colour to represent a particular label. Other variants will occur to those skilled in the art, and combinations of the above are also contemplated.

It will now be apparent to those skilled in the art that labels can be assigned to individual messages in a group of related messages, or alternatively to all messages within the group of related messages. The control of display 120 by processor 108, executing messaging application 160, will now be discussed in connection with enabling the assignment of labels to messages.

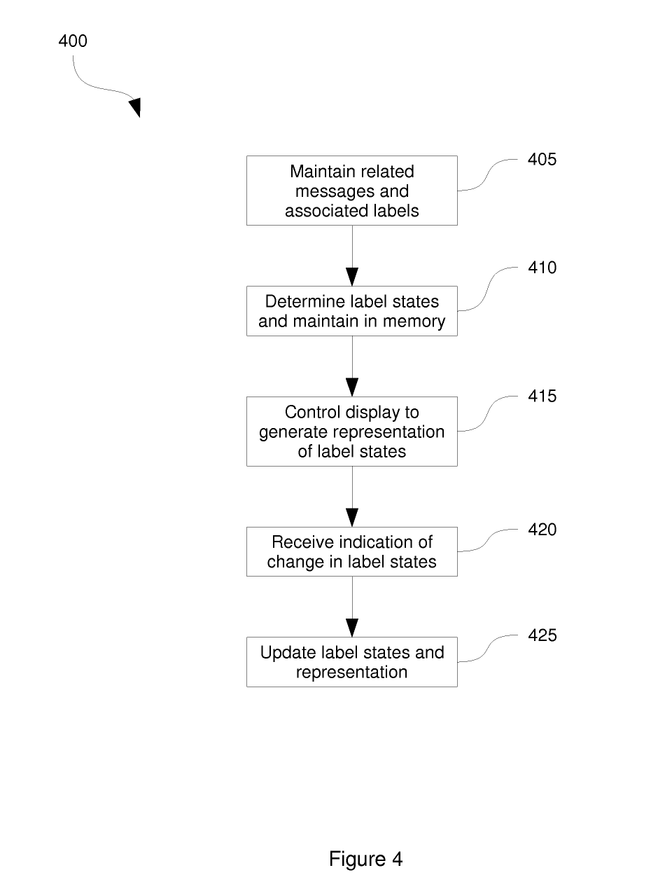

Referring to FIG. 4, a method 400 of controlling a display is depicted. While the performance of method 400 will be described in conjunction with its performance on mobile electronic device 104, it will be understood that method 400 can also be performed on other computing devices. In general, through the performance of method 400, mobile electronic device 104 can be configured to provide, on display 120, a representation of a state for each label used in messaging application 160. As will be seen below, mobile electronic device 104 can further be configured to dynamically update the state representations shown on display 120. Such dynamic updating can happen every time an indication is received that label states may have changed (such as the receipt of a new message).

Beginning at block 405, processor 108 can be configured, via execution of messaging application 160, to maintain e-mail messages 200 and their associated labels in message store 156, as described above.

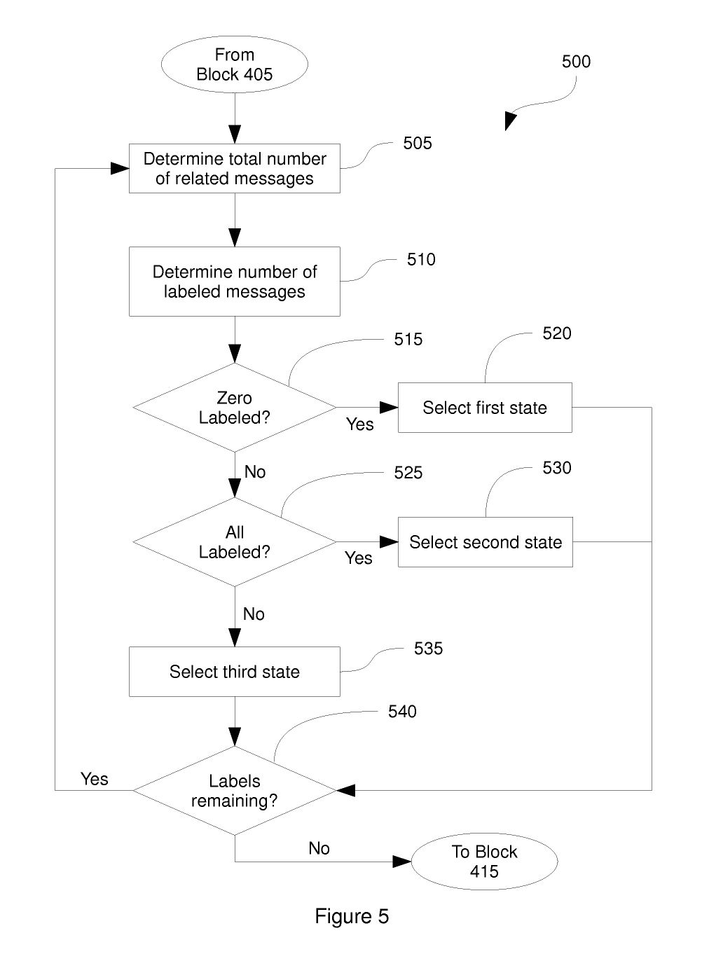

Proceeding to block 410, processor 108 can be configured to determine a state for each label based on the number of related messages with which the respective label is associated. An exemplary method 500 for determining label states during the performance of block 410 is depicted in FIG. 5.

Referring now to FIG. 5, performance of method 500 begins at block 505, at which processor 108 can be configured to determine the total number of related messages in a thread. The performance of block 505 with regards to e-mail messages 200a, 200b and 200c in message store 156 would result in a determination that there are three related messages.

Proceeding to block 510, processor 108 can be configured to determine the number of the related messages with which a label is associated in message store 156. As can be seen from FIG. 2, the result of the determination at block 510 would be zero for all labels except for “Star”. The result for the label “Star” would be three, as each one of e-mail messages 200a, 200b and 200c includes the label “Star”.

The performance of method 500 continues at block 515, at which processor 108 can be configured to determine whether the number messages with the label currently being processed is zero. If the determination at block 515 is affirmative, method 500 proceeds to block 520, at which a first state is selected for the label. The first state is the “none” state, indicating that none of the related messages are associated with the particular label to which this performance of method 500 is directed.

If, on the other hand, the determination at block 515 is negative, indicating that at least one of the related messages includes the relevant label, method 500 proceeds to block 525. At block 525, processor 108 can be configured to determine whether all the related messages include the relevant label. This determination can be performed by determining whether the number determined at block 505 is equal to the number determined at block 510. If the determination at block 525 is affirmative, method 500 proceeds to block 530, where a second state is selected. The second state is the “all” state, indicating that all the related messages are associated with the particular label to which this performance of method 500 is directed.

When the determination at block 525 is negative, the resulting implication is that some, but not all, of the related messages include the relevant label. Method 500 then proceeds to block 535, at which processor 108 can be configured to select a third state. The third state is the “some” state, indicating that more than zero, but less than all, of the related messages are associated with the particular label to which this performance of method 500 is directed.

When any of blocks 520, 530 and 535 are performed, the selected state can be maintained in memory 112. In particular, referring briefly to FIG. 1, the selected state for each label can be maintained in a state cache 164.

Once a state is selected for a label, processor 108 can be configured to determine at block 540 whether any labels remain to be processed. If labels remain to be processed, method 500 returns to block 505. If no labels remain to be processed (that is, if a state has been determined for each label), method 500 terminates and processor 108 returns to the performance of method 400. It will be understood that method 500 is one exemplary method by which to determine label states, and that the steps of method 500 can be re-ordered and changed, as will occur to those skilled in the art.

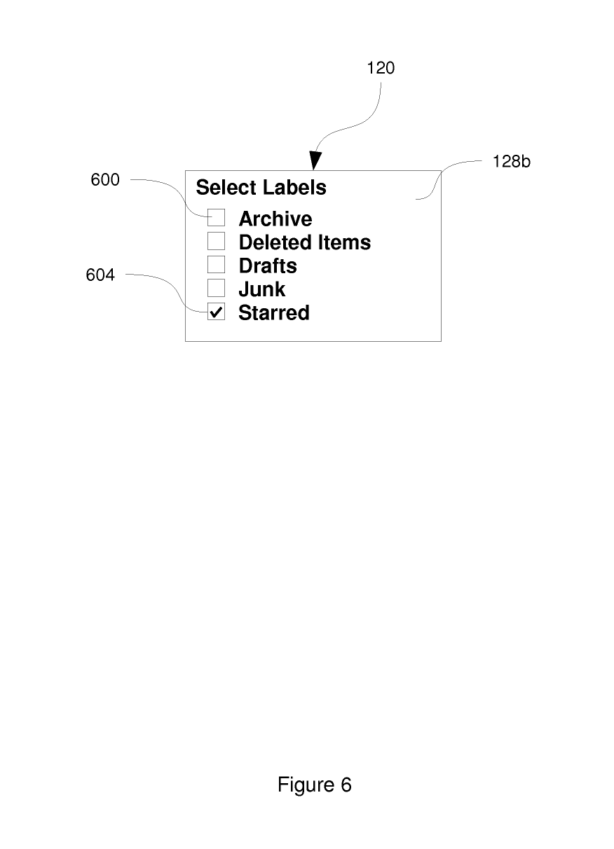

Returning to FIG. 4, performance of method 400 continues at block 415. At block 415, processor 108 can be configured to control display 120 to generate a representation of the label states determined at block 410 and maintained in state cache 164. Referring now to FIG. 6, a representation 128b is shown generated on display 120 under control of processor 108. It will be understood that the generation of representations such as 128b, and indeed the performance of method 400 in general, can be result from a request received from input device 116 to view or change the labels associated with one or more related messages.

Representations 128b includes state indicators for five states (i.e., “Archive”, “Deleted Items”, “Drafts”, “Junk” and “Starred”). As mentioned earlier, the state for all labels other than “Starred” is “none” because no labels other than “Starred” are associated with any of e-mail messages 200. Because all the messages of thread 1 as shown in FIG. 2 include the “Starred” label, the state for the “Starred” label in representation 128b is the “all” state. It will now be apparent that the “none” state can be depicted by an empty check box 600, while the “all” state can be depicted by a checked check box 604. Other depictions, both graphical and textual, can also be used in representations of label states.

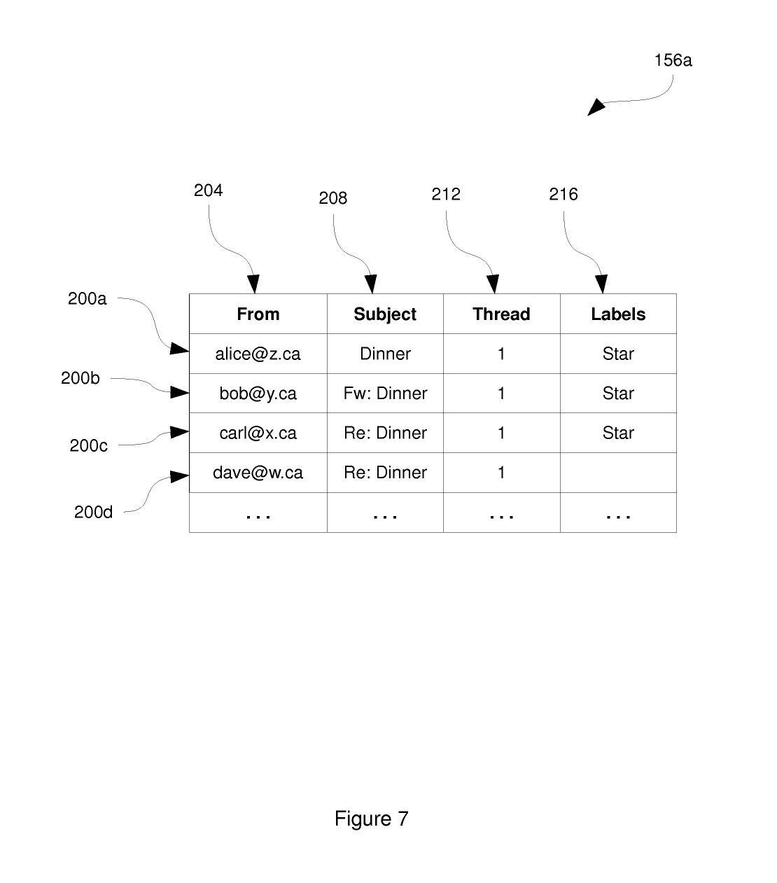

Returning to FIG. 4, performance of method 400 continues at block 420. At block 420, processor 108 can be configured to receive, while controlling display 120 to display the representation generated at block 415, an indication of a potential change in label states. Such an indication can include input data received from input device 116, which may include a request to change the label or labels associated with a message or group of related messages. Such an indication can also include, for example, a new message received from server 144. Turning to FIG. 7, a message store 156a is depicted, in which an additional e-mail message 200d has been received. E-mail message 200d is a member of the same thread as e-mail messages 200a, 200b and 200c, but does not include any labels. The receipt of message 200d indicates that the label states for that thread of messages may have changed.

Referring again to FIG. 4, following receipt of an indication at block 420, method 400 proceeds to block 425. At block 425, processor 108 can be configured to update the label states maintained in state cache 164 and to update the representation generated by display 120. The label states can be updated as described above in connection with block 410 and method 500. In the present exemplary performance of method 400, updating the label states results in the “some” state being selected for the “Starred” label, as e-mail message 200d does not include the “Starred” label.

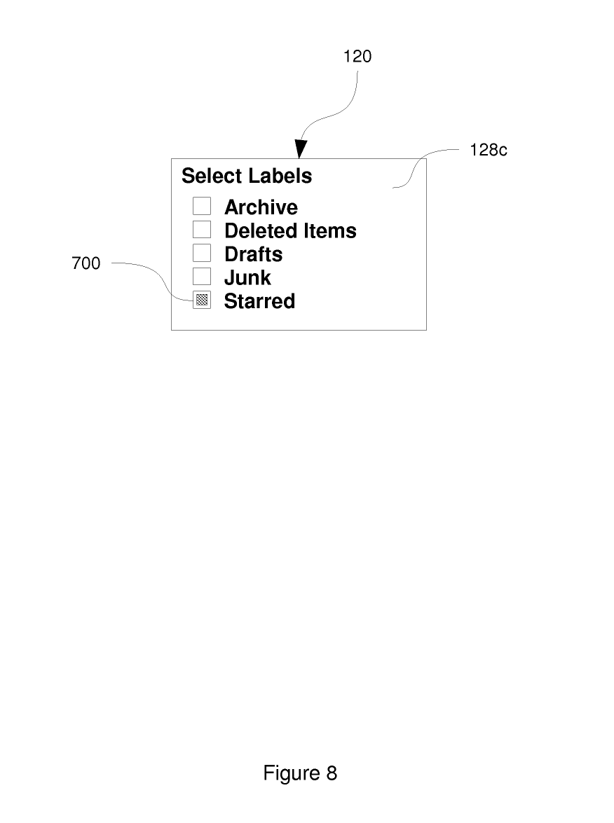

Thus, referring now to FIG. 8, an updated representation 128c is generated by display 120 under the control of processor 108. Representation 128c replaces the previous representation of label states, and includes an indicator 700 for the “some” state, in the form of a partially filled in check box. Again, it will be understood that any suitable indicators can be used in representations 128.

It is contemplated that in some embodiments, block 425 can be performed immediately, or substantially immediately, upon receipt of the indication of a potential change at block 420. With each new indication that is received (that is, with each repetition of the performance of block 420), the performance of block 425 can also be repeated. Representations 128 generated by successive performances of block 425 thus provide a continuously and dynamically updated depiction of label states for a particular group of related messages on display 120.

Those skilled in the art will appreciate that in some embodiments, the functionality of processor 108 executing messaging application 160 may be implemented using pre-programmed hardware or firmware elements (e.g., application specific integrated circuits (ASICs), electrically erasable programmable read-only memories (EEPROMs), etc.), or other related components. In other embodiments, the instructions of messaging application 160 can be stored in a computer readable storage medium other than memory 112. For example, the instructions can be stored remotely but transmittable to processor 108 via a network (e.g. network 140).

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

We claim:

1. A method of controlling a display of a mobile electronic device, the method comprising:
maintaining, in a memory of the portable electronic device, one or more related messages;
maintaining, in the memory, at least one of a plurality of labels in association with at least one of the related messages;
determining, for each of the plurality of labels, a state based on the number of related messages with which the respective label is associated;
controlling the display to generate a representation of the state for each of the labels;
receiving an indication of a potential change in at least one of the label states; and,
responsive to receiving the indication, updating the determined label states and controlling the display to generate an updated representation.

2. The method of claim 1, wherein the related messages comprise e-mail messages.

3. The method of claim 2, wherein related messages comprise messages having substantially similar subject lines.

4. The method of claim 1, wherein determining a state comprises selecting one of three label states.

5. The method of claim 4, wherein the three label states are “none”, “all” and “some”.

6. The method of claim 5, wherein the representation comprises a three-state check box for each label.

7. The method of claim 1, wherein receiving the indication comprises receiving a new message.

8. A mobile electronic device, comprising:
a display;
a memory for maintaining one or more related messages and at least one of a plurality of labels in association with at least one of the related messages; and,
a processor, the processor configured to determine, for each of the plurality of labels, a state based on the number of related messages with which the respective label is associated;
the processor further configured to control the display to generate a representation of the state for each of the labels;
the processor further configured to receive an indication of a potential change in at least one of the label states, to update the determined label states and to control the display to generate an updated representation.

9. The mobile electronic device of claim 8, wherein the related messages comprise e-mail messages.

10. The mobile electronic device of claim 9, wherein related messages comprise messages having substantially similar subject lines.

11. The mobile electronic device of claim 8, the processor being further configured to select one of three label states as part of the state determination.

12. The mobile electronic device of claim 11, wherein the three label states are “none”, “all” and “some”.

13. The mobile electronic device of claim 12, wherein the representation comprises a three-state check box for each label.

14. The mobile electronic device of claim 8, the processor being configured to receive an indication by receiving a new message.

15. A computer readable storage medium for storing computer readable instructions for execution by a processor, the computer readable instructions implementing a method comprising:
maintaining, in a memory of the portable electronic device, one or more related messages;
maintaining, in the memory, at least one of a plurality of labels in association with at least one of the related messages;
determining, for each of the plurality of labels, a state based on the number of related messages with which the respective label is associated;
controlling the display to generate a representation of the state for each of the labels;
receiving an indication of a potential change in at least one of the label states; and,
responsive to receiving the indication, updating the determined label states and controlling the display to generate an updated representation.

16. The computer readable storage medium of claim 15, wherein the related messages comprise e-mail messages.

17. The computer readable storage medium of claim 16, wherein related messages comprise messages having substantially similar subject lines.

18. The computer readable storage medium of claim 15, wherein determining a state comprises selecting one of three label states.

19. The computer readable storage medium of claim 18, wherein the three label states are “none”, “all” and “some”.

20. The computer readable storage medium of claim 19, wherein the representation comprises a three-state check box for each label.

21. The computer readable storage medium of claim 15, wherein receiving the indication comprises receiving a new message.
